(19) United States
(12) Patent Application Publication
(10) Pub. No.: US 2017/0056266 A1
(43) Pub. Date: Mar. 2, 2017

(54) INTEGRATED AMBULATORY ASSISTANCE APPARATUS FOR USE WITH A VARIETY OF MOBILITY DEVICES

(71) Applicant: Matti W. Palo, Covington, LA (US)

(72) Inventor: Matti W. Palo, Covington, LA (US)

(21) Appl. No.: 14/838,783

(22) Filed: Aug. 28, 2015

(51) Int. Cl. A61G 7/10

(52) U.S. Cl. CPC A61G 7/1038

(57) ABSTRACT

Embodiments described herein include an integrated mobility assistance apparatus that is designed to assist a user to transition from a seated to a standing position, and store a plurality of customized accessories within a hollow region of a handle element. The integrated mobility assistance apparatus contains at least one mounting sleeve and at least one handle element that may be releasably attached to at least a shaft of an ambulatory aid. The at least one mounting sleeve may be adjustable to a desired height, and the at least one handle may transition from an at least substantially horizontal to vertical position to enable a patient to grip the handle element for additional balance support when transitioning from a plurality of positions using a pivot pin.

### FIELD

The present embodiment relates to an integrated ambulatory assistance apparatus, and in particular, an integrated ambulatory assistance apparatus that is designed to assist a user while transitioning between a seated and standing position and stores a plurality of customized accessories including at least a wireless transmitter and at least one accelerometer within a hollow region of the handle element.

### BACKGROUND

Gait and balance disorders are most prevalent in senior adults and the primary cause of falls amongst the elderly. These gait and balance disorders are often associated with morbidity, mortality, and reduced function within the limbs and musculoskeletal system. Some of the major causes of gait and balance disorders include degenerative arthritis and hemochromatosis which are often irreversible and render only minimal results from medical and surgical procedures. Further, gait and balance disorders affect over 35 percent of elderly adults living in the United States and often require them to turn to ambulatory aids to assist with basic mobility.

Currently, many candidates for mobility aids do not receive physical examinations prior to purchasing an ambulatory device, and may receive an improperly fitted device, which leads to over 47,000 elderly adults requiring emergency medical attention every year. Proper ambulatory aid fitting requires a medical professional to balance a host of factors including: cognitive and vestibular function, vision, upper body strength, weight-bearing status, fall risk, and living conditions. Without a proper examination or fitting, many of these basic devices may increase the risk for future imbalance and fall-related injuries.

Furthermore, many basic ambulatory devices on the market are issued to patients without considering the unique medical needs of the patient. For example, a patient may be initially fitted with a multi-legged ambulatory aid but is required to climb a set of stairs to reach their home, in which case a wider based cane could be dangerous for the patient. Furthermore, the unique needs of a patient with an ambulatory aid device continuously change over time, and the current “one-size-fits-all” approach leads to future injury and exacerbate current disorders.

Currently, there are several ambulatory devices used in the market to treat chronic gait and balance disorders associated with sitting, standing, and transfer control. Specifically, U.S. Pat. No. 90,162,975 to Salomon; U.S. Pat. No. 8,944,458 to Ferez/Delgado; and U.S. Pat. No. 8,573,612 to Fulk/Carroll. Though each of these references disclose certain aspects associated with mobility aid, they are limited in their ability to provide personalized ambulatory assistance to the user or incorporate any customized accessories within.

### SUMMARY OF THE INVENTION

Embodiments described herein include an integrated ambulatory aid apparatus for use with a variety of mobility devices. Some embodiments include an ambulatory aid apparatus designed to assist a patient with gait and balance disorders transfer between a plurality of positions including a seated and standing position without compromising their base of support. Some embodiments include a releasably attachable mounting sleeve which is releasably secured to a substantially cylindrical handle element by a pivot pin to enable a user to shift the handle element and engage a locking mechanism in a plurality of positions. The releasably attachable mounting sleeve is dimensionally configured to be fitted at a desired height to varying diameter ambulatory aid shafts. The substantially cylindrical handle element is releasably attachable to the mounting sleeve about a pivot pin that is releasably housed within a bored housing space located within the mounting sleeve and handle element. The pivot pin is designed to enable a user to shift the handle element from a substantially horizontal to vertical position as the user transitions between positions and re-engage the locking mechanism. The handle element is configured to be releasably seated and locked onto an elongated collar of the releasably attachable mounting sleeve in the substantially horizontal position. The handle element further includes a substantially hollow region to enable a user to store a plurality of customized accessories including at least an accelerometer and a wireless transmitter within the hollow region. The user may access the substantially hollow region of the handle element by opening/closing the releasably attachable press fit end cap which is attached by a hinge and configured to securely fit around the diameter of the handle element for secure storage.

Other aspects, advantages, and novel features of the embodiments will become apparent from the following detailed description in conjunction with the drawings.

### BRIEF DESCRIPTION OF THE DRAWINGS

A more complete understanding of the embodiments, and the attendant advantages and features thereof, will be more readily understood by reference to the following detailed description when considered in conjunction with the accompanying drawings wherein:

FIG. 1 is a perspective view of an integrated ambulatory aid apparatus shifting from the substantially horizontal to vertical position;

FIG. 2 is a detailed view of the second end of the handle element wherein the press fit end cap is partially detached from the second end of the handle element exposing the hollow region;

FIG. 3 is a detailed view of the mounting sleeve attached to the handle element;

FIG. 4 is a perspective view of the mounting sleeve and elongated collar; and

FIG. 5 is a perspective view of the handle element.

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

Some embodiments include an integrated ambulatory assistance apparatus for use with a variety of mobility assistance devices. The apparatus is configured to be releasably attached to a plurality of ambulatory aid shafts and may be releasably rotated or adjusted to a desired height based on a user's preference. The apparatus is further designed to assist a user in transitioning from one position to another including the seated and standing position by disengaging a locking mechanism, and shifting the handle element from a substantially horizontal to vertical position. The apparatus is includes a releasably attachable mounting sleeve that is configured to be releasably attached to a shaft of an ambulatory aid at a desired height. The releasably attached mounting sleeve is releasably secured to a handle element about a pivot pin to enable the user to disengage a locking mechanism, shift the handle element to at least the substantially horizontal or vertical position, and re-engage the locking mechanism. The pivot pin is dimensioned to fit within a bored housing space of the releasably attachable mounting sleeve and at a first end of the handle element. A second end of the handle element further includes a releasably attachable press fit end cap to allow the user to store a plurality of customized accessories including at least a three-axis programmable accelerometer and wireless transmitter within a hollow region of the handle element.

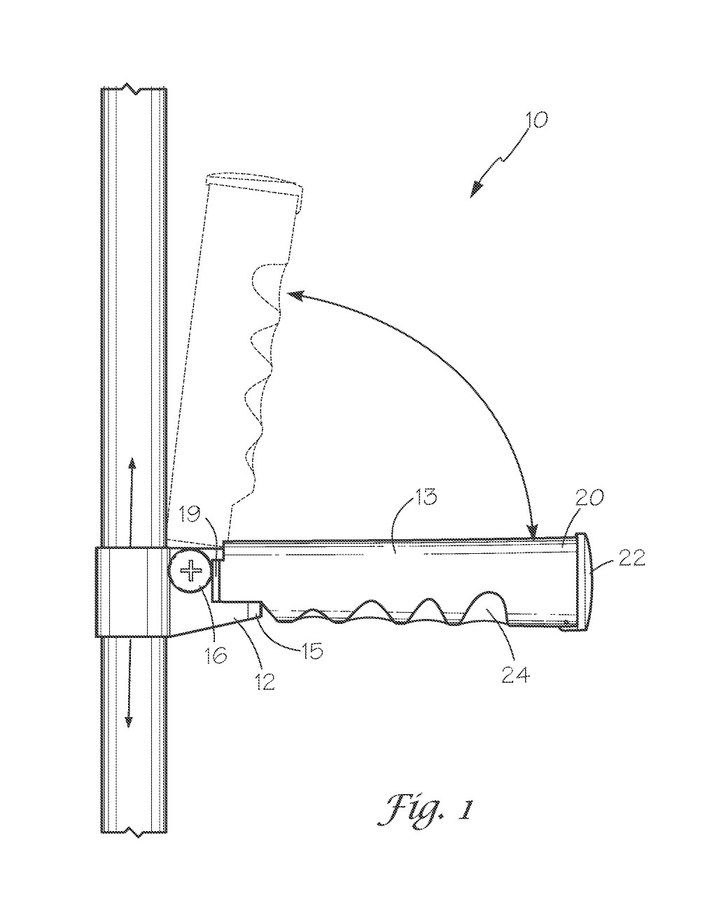

Referring now to the drawings wherein like reference numerals designate identical or corresponding parts throughout the views, there is shown in FIG. 1 a perspective view of an integrated ambulatory assistance apparatus 10. In the embodiments of FIG. 1, the apparatus 10 includes a mounting sleeve 12 and a handle element 13 which are composed of high durometer material to prevent cracking or shattering in the event the apparatus 10 is dropped. The mounting sleeve 12 is adjustably configured to fit on any one of a plurality of shafts of varying diameter. Further, the mounting sleeve 12 may be positioned at a desired height onto a shaft of an ambulatory aid 14 to provide an optimal base of support based on the user's height and posture. The mounting sleeve 12 further includes an elongated collar 15 that is substantially perpendicular to the shaft of an ambulatory aid 14. The substantially elongated collar 15 is configured to releasably seat the handle element 13 and provide additional lateral support in the substantially horizontal position to assist a user with hand placement while transitioning between a plurality of positions including at least the seated and standing position.

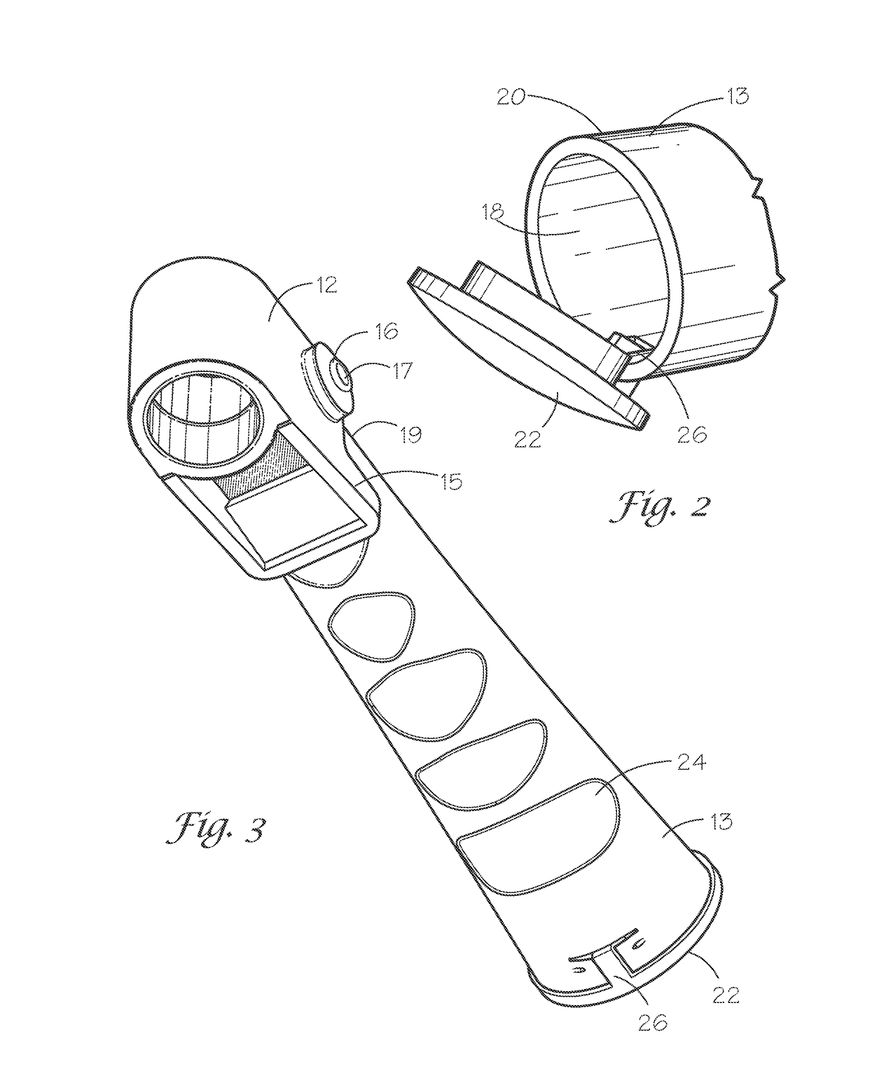

The mounting sleeve 12 and the handle element 13 are releasably affixed about a pivot pin 16. The pivot pin 16 is composed of a fiberglass, steel (set screw), or aluminum material to prevent cracking in the event of a fall or rusting from moisture or weather exposure. Further, the pivot pin 16 is releasably configured to fit tightly within a bored housing space 17 (not shown in FIG. 1) of the mounting sleeve 12 and handle element 13 to provide a secure fitting and prevent any margin of latitude. The pivot pin 16 is further configured to enable a user to apply an upward/downward force onto the handle element 13 and place the handle element 13 in at least the substantially vertical or horizontal position. The handle element 13 has an elongated and substantially cylindrical configuration and is designed to assist a user with gait or imbalance disorders by increasing their base of support. Furthermore, the handle element 13 includes a hollow region 18 (shown in FIG. 2) within the handle element 13 to store a plurality of customized accessories (not shown in FIG. 1) including at a wireless transmitter and a three-axis programmable accelerator with integrated memory module.

The handle element 13 includes a first end 19 and second end 20, the first end 19 is dimensionally configured to be attached to the mounting sleeve 12 by inserting the pivot pin 16 within the bored housing space 17 of the mounting sleeve 12 and handle element 13. The second end 20 is substantially cylindrical and dimensioned to be releasably fitted with a press fit end cap 22 which is designed to store a plurality of customized accessories within the hollow region 18. The press fit end cap 22 may be removed by the user asserting a substantially horizontal force on a portion of the press fit end cap 22 to enable inserting/removing accessories from the hollow region 18 with a single hand without requiring the user to bend down or compromise balance. The plurality of customized accessories that may be inserted within the hollow region 18 of the handle element 13 are based on the user's personal medical needs. For example, the user may need to take medication periodically throughout a day in which a dimensioned pill box stored within the hollow region 18 would be the proper customized accessory. While a different user may want to store an emergency monitor with a wireless transmitter within the hollow region 18 to notify a dispatch center and/or designated contact during an emergency. These customized accessories also at least include: a pill box with smart technology to indicate times to take medication; a three-axis programmable accelerometer with integrated memory module which tracks the gait parameters of the user including stance and base supports; and further includes a wireless transmitter with embedded location information to notify emergency centers and/or designated contacts in the event of a fall.

The handle element 13 further includes a portion of finger grooves 24 composed of a low durometer material and configured to prevent slippage, and provide enhanced grip to the user by enabling the user to place their fingers within the finger grooves 24 for support.

FIG. 2 is a detailed view of the second end 20 of the handle element 13 and partially detached press fit end cap 22 displaying a portion of the hollow region 18. The press fit end cap 22 is composed of a low durometer material which is designed to be attached/de-attached by applying the press fit end cap 22 against the second end 20 of the handle element 13. The press fit end cap 22 is designed to provide a water-proof seal to prevent the plurality of accessories from water damage while attached to the second end 20. The plurality of customized accessories includes at least a three-axis programmable accelerometer, and a wireless transmitter. The three-axis programmable accelerometer may detect falls by sensing body or apparatus position changes, and changes in motion. The change is most apparent from the “G-Force” impact during the fall. The three-axis programmable accelerometer can detect changes in acceleration that can differentiate between a user sitting, and dropping the apparatus 10. The three-axis programmable accelerometer also detects changes in the x and y axis, determining a change in position of the apparatus. Additionally, the accelerometer is designed to collect and store data on gait parameters within the integrated memory module. The data may include such factors as stride length, pace, variability, and stance time.

The press fit end cap 22 is releasably attached to the second end 20 of the handle element 13 using a hinge 26 to enable the user to open/close the press fit end cap 22 by applying a force against of the press fit end cap 22 and the second end 20 of the handle element 13. The mounting sleeve 12 is releasably attached to the shaft of an ambulatory aid 14 and may further be rotatable about the shaft of an ambulatory aid 14. The handle element 13 moves in a downward motion as it transitions between positions. Further a locking mechanism 28 is disengaged, enabling the handle element 13 to shift and be re-engaged in the substantially horizontal or vertical positions and provide additional stability in assisting a user transition from a seated to standing position.

FIG. 3 is detailed view of the mounting sleeve 12 and handle element 13 detached from the shaft of an ambulatory aid 14. Specifically, the handle element 13 is releasably seated onto the elongated collar 15 in the substantially horizontal position. Furthermore, the detailed view includes a portion of the handle element 13 which includes a substantially grooved portion 24 as well as the press fit end cap 22 and releasably attached hinge 26.

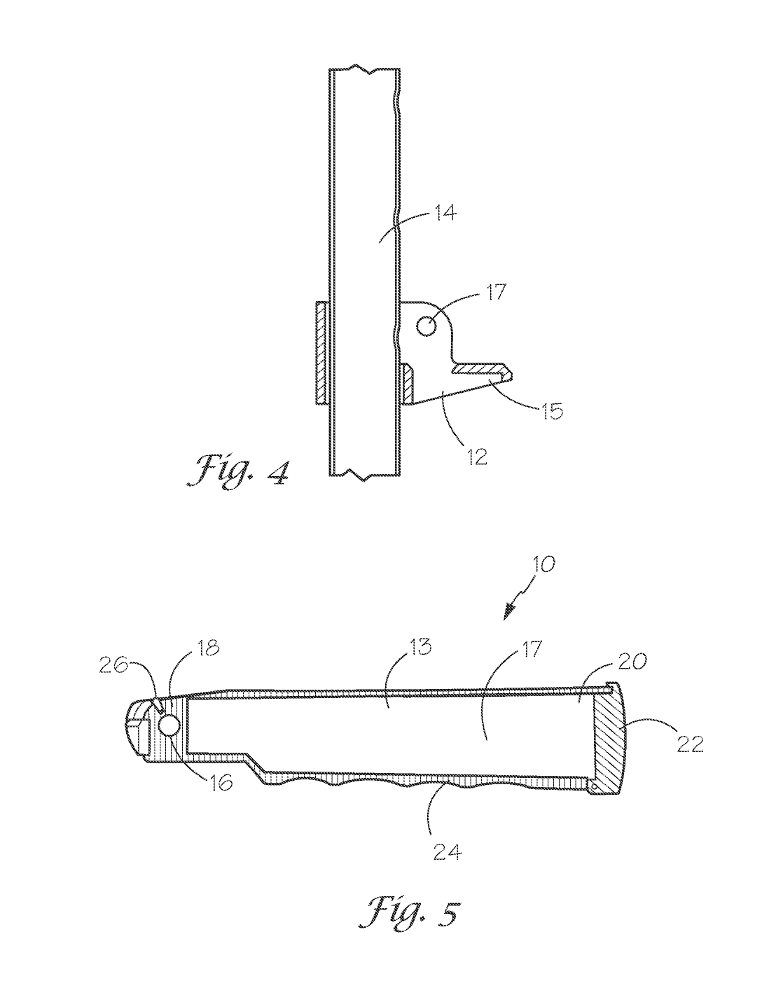

FIG. 4 is a perspective view of the mounting sleeve attached to the shaft of an ambulatory aid 14. The mounting sleeve 12 is configured to be rotatable about the shaft of the ambulatory aid 14 and may be releasably attached at a desired height based on the user preference and posture. For example, a user may prefer to have to height in a lower vertical position about the shaft of an ambulatory aid 14 to help a user with kyphosis. The user may then remove the mounting sleeve 12 from the shaft of an ambulatory aid 14 and releasably secure the apparatus 10 onto the diameter of a different shaft. Further, the current figure shows the bored housing space 17 which releasably attaches the handle element 13 to the mounting sleeve 12 about the pivot pin 16 as demonstrated in FIG. 1.

FIG. 5 is a perspective view of the handle element detached from the mounting sleeve 12. The current view demonstrates the locking mechanism 28 which is composed of a high durometer material with an internal spring which is actuated when the user applies a force against a top surface of the first end 19 to engage with the shaft of an ambulatory aid 14 as demonstrated in FIG. 1.

It will be appreciated by persons skilled in the art that the present embodiment is not limited to what has been particularly shown and described herein above. In addition, unless mention was made above to the contrary, it should be noted that all of the accompanying drawings are not to scale. A variety of modifications and variations are possible in light of the above teachings without departing from the following claims.

What is claimed is:

1. An integrated mobility assistance apparatus for use with a variety of ambulatory aids, comprising:
a mounting sleeve configured to be removably affixed at a desired position about a shaft of an ambulatory aid; and
a handle element; the handle element pivotally attached to the mounting sleeve to be grasped to allow a user to transition between a seated position and a standing position.

2. The apparatus of claim 1, wherein the mounting sleeve further includes a pivot pin which is releasably attached to the handle element to enable a user to transition the handle element between a substantially horizontal position and a vertical position.

3. The apparatus of claim 2, wherein the mounting sleeve is substantially elongated and is positioned substantially perpendicular to the shaft of the ambulatory aid and configured to seat the handle element.

4. The apparatus of claim 3, wherein the mounting sleeve is adjustably configurable to fit a diameter of an ambulatory aid shaft.

5. The apparatus of claim 1, wherein the handle element further includes at least one locking mechanism configured to releasably secure the handle element to the shaft of the ambulatory aid in at least one of the substantially horizontal and vertical positions.

6. The apparatus of claim 5, wherein the handle element further includes a plurality of finger grooves configured to accommodate a hand of a user of the ambulatory aid.

7. The apparatus of claim 6, wherein the handle element includes a releasably securable fitting covering a hollow region of the handle configured to allow a user to house at least one accessory within a hollow region of the handle element.

8. An integrated mobility assistance apparatus for use with a variety of ambulatory aids, comprising:
a releasably adjustable mounting sleeve, the releasably adjustable mounting sleeve configured to be releasably affixed to a shaft of an ambulatory aid at a desired height and further including a pivot pin, the pivot pin configured to releasably and pivotally secure a handle element; and
a handle element, the handle element including a first and second end; the first end further including a dimensioned opening configured to releasably secure the adjustable mounting sleeve about the pivot pin to allow the handle element to transition from a substantially horizontal to a vertical position and assist a user to transition between a seated position and standing position, and the second end of the handle element including a dimensioned fitting configured to allow a user to open and close the dimensioned fitting and house a plurality of accessories within a hollow region of the handle element.

9. The apparatus of claim 8, wherein the releasably adjustable mounting sleeve is adjustable to be releasably secured to a diameter of an ambulatory aid shaft.

10. The apparatus of claim 8, wherein the handle element further includes at least one locking mechanism configured to releasably secure the handle element in one of the substantially horizontal and vertical positions.

11. The apparatus of claim 10, wherein the handle element further includes a plurality of finger grooves to enable a user to grasp the handle element.

12. The apparatus of claim 11, wherein the second end of the handle element further includes a hinge configured to releasably attach the dimensioned fitting to the handle element.

13. The apparatus of claim 12, wherein the handle element is hollow to store at least one accessory.

14. The apparatus of claim 13, wherein the at least one accessory further includes a three-axis programmable accelerometer with an integrated memory module and a wireless transmitter to alert a monitor or designated contact that a user of the ambulatory aid has fallen.

15. The apparatus of claim 14, wherein the wireless transmitter is dimensioned to fit within a pill box to alert a user to take a medication.

16. An integrated mobility assistance apparatus for use with a variety of ambulatory aids, comprising:
at least one mounting sleeve; the at least one mounting sleeve configured to be releasably affixed about a shaft of an ambulatory aid at a desired height; and
at least one handle element, the at least one handle element releasably affixed to the at least one mounting sleeve at a pivot pin, and having a first and second end; the first end further including at least one dimensioned opening to secure the at least one mounting sleeve using a set screw, and the second end further including a releasably securable fitting configured to allow a user to unsecure the releasably securable fitting and place at least one accessory within a hollow region of the at least one handle element.

17. The apparatus of claim 16, wherein the at least one mounting sleeve further includes an elongated collar configured to releasably seat the at least one handle element and assist a user to transition from the at least seated to standing position.

18. The apparatus of claim 17, wherein the at least one handle further includes a grooved portion configured to releasably house at least one finger while in use.

19. The apparatus of claim 18, wherein the at least one handle further includes at least one locking mechanism configured to releasably secure the at least one handle in the at least substantially horizontal and vertical positions.

20. The apparatus of claim 18, wherein the at least one accessory further includes at least a pill box or at least one wireless transmitter.
